(19) United States
(12) Patent Application Publication
(10) Pub. No.: US 2017/0039439 A1
(43) Pub. Date: Feb. 9, 2017

(54) PARKING SPACE RECOGNITION APPARATUS AND METHOD OF CONTROLLING THE SAME

(71) Applicant: HYUNDAI MOBIS CO., LTD., Yongin-si (KR)

(72) Inventor: Hoon Min KIM, Yongin-si (KR)

(21) Appl. No.: 15/227,057

(22) Filed: Aug. 3, 2016

(30) Foreign Application Priority Data
Aug. 3, 2015 (KR) 10-2015-0109643

(51) Int. Cl. G06K 9/00; B60R 1/00

(52) U.S. Cl. CPC G06K 9/00812; G06K 9/00798; B60R 1/00; B60R 2300/806

(57) ABSTRACT

Disclosed are a parking space recognition apparatus and a method of controlling the same. The method may include calculating an estimated location value for any one of a plurality of crossings included in a parking space from an around view monitoring image, determining whether stored registered location values for one or more prerecognized existing crossings are present among the plurality of crossings, determining whether a registered location value matching the estimated location value is present among the stored registered location values if the stored registered location values are present, correcting the matched registered location value based on the estimated location value if the registered location value matching the estimated location value is present, and replacing a registered location value for an existing crossing corresponding to the estimated location value with the corrected registered location value and storing the corrected registered location value.

### CROSS-REFERENCE TO RELATED APPLICATION

This application claims priority from and the benefit of Korean Patent Application No. 10-2015-0109643, filed on Aug. 3, 2015, which is hereby incorporated by reference for all purposes as if fully set forth herein.

### BACKGROUND

Field

Exemplary embodiments relate to a parking space recognition apparatus and a method of controlling the same and, more particularly, to a parking space recognition apparatus for detecting crossings of parking lines drawn on a road surface and recognizing a parking space in which a vehicle is capable of being parked based on the detected crossings and a method of controlling the same.

Discussion of the Background

A vehicle refers to an apparatus that transports people, cargo, and the like from one place to another. Recently, a parking assist system has been developed and commercialized as a technological development for increasing the convenience of a user who drives a vehicle.

The parking assist system installed in a vehicle recognizes a parking space around the vehicle based on an around view monitoring (AVM) image illustrated in FIG. 1 to inform a driver of whether parking is possible and, when necessary, outputs a dangerous situation alarm to a driver using a sound signal or an optical signal. In some cases, the parking assist system is in charge of control of steering and speed for parking.

To implement the parking assist system, at least one sensor for recognizing a parking space, such as a camera or an ultrasonic sensor, needs to be installed in the vehicle.

In order to recognize a parking space based on an AVM image, the parking assist system should detect a plurality of crossings included in the parking space as a preliminary process of parking space recognition.

The AVM image generally incurs a large error in a region corresponding to a location distant from a camera, as illustrated in FIG. 1. To solve this problem, a scheme of detecting crossings with respect to only regions corresponding to a predetermined range from cameras among all regions of the AVM image has been proposed. However, to do this, the vehicle should enter a region within a given distance of a parking space, which causes inconvenience in that the time required to recognize the parking space becomes large.

Referring to FIG. 2, a parking space recognition apparatus based on an AVM image according to the prior art stores all location values for a detected crossing in sequentially generated image frames until a parking space is recognized. That is, the parking space recognition apparatus stores a plurality of location values with respect to one crossing and calculates an average of the location values, thereby detecting a final location of the crossing. In this case, an excessive amount of memory is used and the number of calculations for detecting a crossing increases.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a parking space recognition apparatus capable of reducing memory use and computational load needed to recognize a parking space by storing only one location value with respect to each crossing included in the parking space, and a method of controlling the same.

Additional aspects will be set forth in the detailed description which follows, and, in part, will be apparent from the disclosure, or may be learned by practice of the inventive concept.

An exemplary embodiment discloses a method of controlling a parking space recognition apparatus, including calculating an estimated location value for any one of a plurality of crossings included in a parking space, from an around view monitoring (AVM) image, determining whether stored registered location values for one or more prerecognized existing crossings are present among the plurality of crossings, one registered location value corresponding to one existing crossing, determining whether a registered location value matching the estimated location value is present among the stored registered location values if the stored registered location values are present, correcting the matched registered location value based on the estimated location value if the registered location value matching the estimated location value is present, and replacing the registered location value for an existing crossing corresponding to the estimated location value with the corrected registered location value and storing the corrected registered location value.

If the stored registered location values are not present or the registered location value matching the estimated location value is not present among the stored registered location values, the method may further include processing a crossing corresponding to the estimated location value as a new crossing and storing the estimated location value as a registered location value for the new crossing.

The determining of whether the registered location value matching the estimated location value is present may include calculating a distance between the estimated location value and each of the stored registered location values, and if the calculated distance is less than a preset reference distance, determining that the registered location value matching the estimated location value is present and, if the calculated distance exceeds the reference distance, determining that the registered location value matching the estimated location value is not present.

The method may further include obtaining a reliability index for the estimated location value.

The obtaining the reliability index may include selecting a sub-region to which the estimated location value belongs among a plurality of predefined sub-regions with respect to an entire region of the AVM image, and obtaining a preset reliability index with respect to the selected sub-region.

The correcting the matched registered location value may include correcting the matched registered location value based further on the obtained reliability index.

The method may further include calculating a size and location of the parking space based on registered location values including the corrected registered location value, and generating a parking path for the parking space based on the size and location of the parking space.

An exemplary embodiment discloses a parking space recognition apparatus that includes an information storage unit, an image synthesis unit configured to generate an around view monitoring (AVM) image, and a control unit configured to calculate an estimated location value for any one of a plurality of crossings included in a parking space, from the AVM image, determine whether stored registered location values for one or more prerecognized existing crossings are present among the plurality of crossings, determine whether a registered location value matching the estimated location value is present among the stored registered location values when the stored registered location values are present, correct the matched registered location value based on the estimated location value when the registered location value matching the estimated location value is present, and replace a registered location value for an existing crossing corresponding to the estimated location value with the corrected registered location value and store the corrected registered location value, wherein one registered location value corresponds to one existing crossing.

If the stored registered location values are not present or the registered location value matching the estimated location value is not present among the stored registered location values, the control unit may process a crossing corresponding to the estimated location value as a new crossing and stores the estimated location value as a registered location value for the new crossing.

The control unit may calculate a distance between the estimated location value and each of the stored registered location values, determine that the registered location value matching the estimated location value is present if the calculated distance is less than a preset reference distance, and determine that the registered location value matching the estimated location value is not present if the calculated distance exceeds the reference distance.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 and FIG. 2 are diagrams referred to in explaining problems in the prior art.

FIG. 3 is a block diagram of a parking space recognition apparatus according to an exemplary embodiment.

FIG. 4 is a flowchart illustrating a method of controlling the parking space recognition apparatus according to an exemplary embodiment.

FIG. 5 illustrates an example of detecting a crossing of a parking space from an AVM image by the parking space recognition apparatus according to an exemplary embodiment.

FIG. 6 illustrates an example of a reliability index set with respect to each region of an AVM image according to an exemplary embodiment.

FIG. 7 illustrates an example of detecting the location of a new crossing from an AVM image by a parking space recognition apparatus according to an exemplary embodiment.

FIG. 8 illustrates an example of correcting a location value calculated for an existing crossing from an AVM image by the parking space recognition apparatus according to an exemplary embodiment.

FIG. 9 is a diagram illustrating an example of a correction result by the parking space recognition apparatus according to an exemplary embodiment.

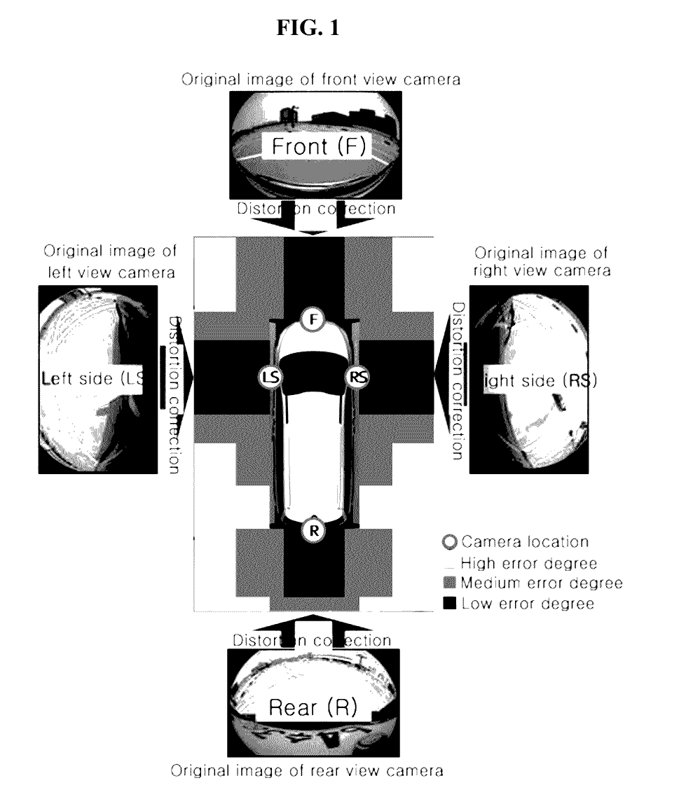

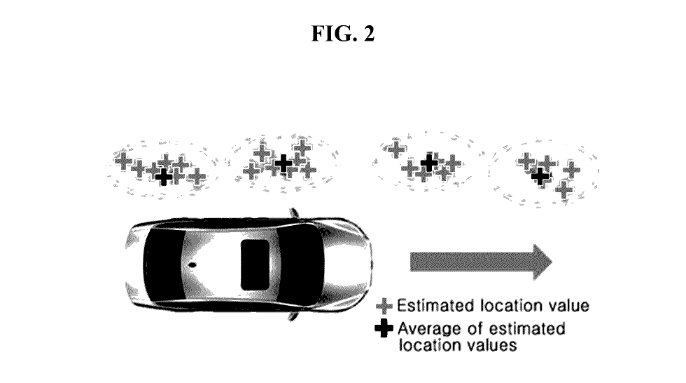

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

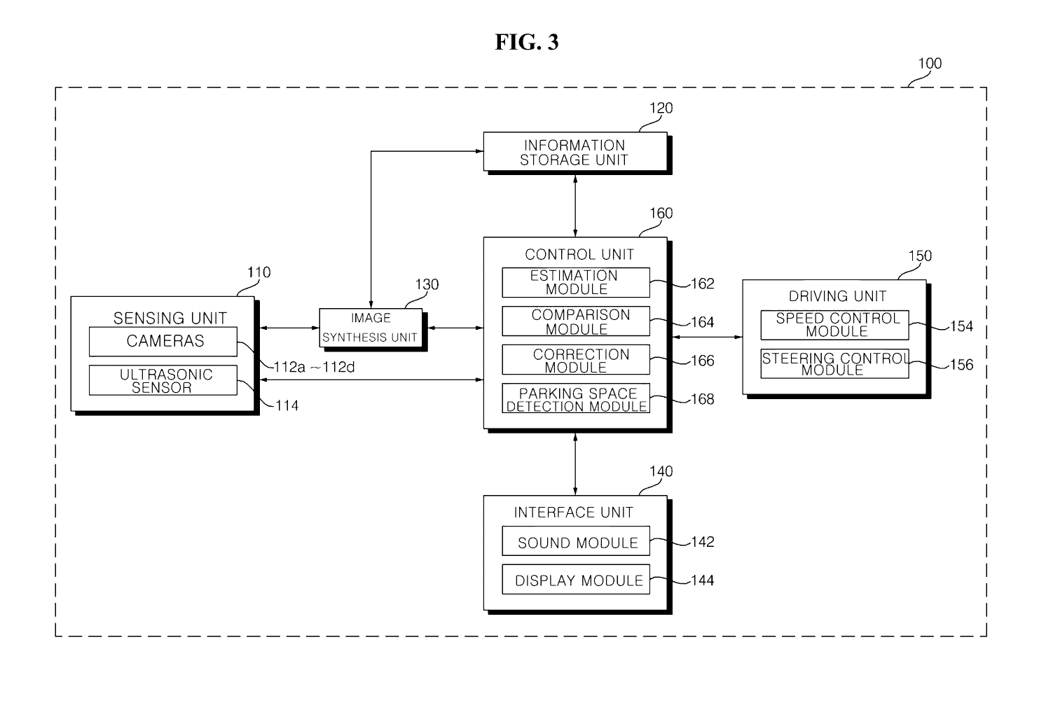

FIG. 3 is a block diagram of a parking space recognition apparatus 100 according to an exemplary embodiment.

Referring to FIG. 3, the parking space recognition apparatus 100 according to an exemplary embodiment includes a sensing unit 110, an information storage unit 120, an image synthesis unit 130, an interface unit 140, a driving unit 150, and a control unit 160.

The sensing unit 110 senses various objects around a vehicle and generates sensing signals corresponding to the objects. The sensing signals may be signals generated by the sensing unit 110.

The sensing unit 110 may include at least one sensor. The sensing unit 110 may include at least one of cameras 112a to 112d and an ultrasonic sensor 114. However, types of sensors are not limited thereto and any sensor capable of sensing objects, such as a radar or Lidar, may be the sensor of the sensing unit 110.

The cameras 112a to 112d may capture the surroundings of a vehicle to generate surrounding images.

Any one of the cameras 112a to 112d may be installed at one side of the front of a vehicle and may generate a front view image of the vehicle.

The cameras 112a to 112d may be respectively installed at front, rear, left, and right sides of the vehicle and may generate front view, rear view, left side view, and right side view images, respectively. The multiple images may be synthesized by the image synthesis unit 130 which will be described later. Through such a synthesis process, an AVM image like an image generated when a user looks down the vehicle may be generated.

Although four cameras are illustrated in FIG. 3, it should be understood that fewer or more cameras may be included in the sensing unit 110.

The ultrasonic sensor 114 may sense obstacles in the vicinity of the vehicle and generates sensing signals corresponding to the sensed obstacles. The ultrasonic sensor 114 may generate sensing signals corresponding to a second time point at which an ultrasonic signal emitted at a first time point may be reflected by an obstacle and returned back as a reflected signal.

The information storage unit 120 may store information regarding a parking space and a vehicle.

Specifically, the information storage unit 120 may store an estimated location value calculated by the control unit 160, which will be described later, and a registered location value. In this case, the estimated location value indicates a value estimated to be a location of any one of a plurality of crossings included in a parking space and the registered location value indicates a value stored as a location of a prerecognized crossing among a plurality of crossings included in a parking space.

The information storage unit 120 may store information about a valid parking space and information about specifications of a vehicle including the parking space recognition apparatus 100. The valid parking space refers to a parking space in which the vehicle is able to be parked in, and may be a space larger than the size of the vehicle (e.g., the whole width or whole length, and whole height of the vehicle). The control unit 160, which will be described later, may compare information about the valid parking space stored in the information storage unit 120 with information about a parking space sensed by the sensing unit 110 to determine whether the parking space sensed by the sensing unit 110 corresponds to the valid parking space.

The information storage unit 120 may permanently or temporarily store the sensing signals generated by the sensing unit 110.

In addition, while control of a speed or steering of the vehicle along a parking path is performed, if a driver exits the vehicle, the information storage unit 120 may store a location at which the driver exits the vehicle.

The information storage unit 120 may temporarily store various programs for operating the control unit 160 or input/output data.

The information storage unit 120 may provide various stored information to the control unit 160 at the request of the control unit 160.

The information storage unit 120 may store an alarm message for each situation to be generated by the interface unit 140, which will be described later.

The information storage unit 120 may store internal parameters and external parameters for the cameras 112a to 112d.

The information storage unit 120 may store view transformation information. The view transformation information may be information for transforming or reflecting information about any one view into information about another view, for example, information for transforming surrounding images generated by the cameras 112a to 112d into an AVM image or information for mutual transformation between a 3D space and a 2D plane.

The information storage unit 120 may include at least one of various types of storage media such as a random access memory (RAM), a read-only memory (ROM), an electrically erasable programmable read-only memory (EEPROM), a programmable read-only memory (PROM), an information storage unit of a solid state drive (SSD) type, a flash memory type, a hard disk type, or a card type, a magnetic disk, and an optical disc.

The image synthesis unit 130 may synthesize a front view image, a rear view image, a left side view image, and a right side view image provided respectively by the cameras 112a to 112d, thereby generating an AVM image.

The interface 140 may generate information related to a vehicle or a parking space in the form of a signal capable of being recognized by a user, or receive various commands from a driver.

The interface 140 may generate an alarm message urging a driver to exit a vehicle before parking is completed.

The interface 140 may generate an alarm message indicating a danger of collision with an obstacle (e.g., a curb, a wall, or a pedestrian) during vehicle parking or vehicle exit.

The interface 140 may receive a parking command, an outgoing command, a steering command, an acceleration command, a deceleration command, etc. from a driver.

The interface 140 may include a sound module 142 and a display module 144.

The sound module 142 may generate various messages as acoustic signals using a speaker included therein, receive a voice command of a driver using a microphone, convert the voice command into an electric signal, and provide the electric signal to the control unit 160.

The display module 144 may generate various messages as visual signals using a head up display (HUD) included therein. The display module 144 may be a touchscreen including a touch sensor.

The interface 140 may receive various commands such as touch by a driver using a touch sensor or a button, convert the commands into electric signals, and provide the electric signals to the control unit 160.

The driving unit 150 may control driving of a vehicle. The driving unit 150 may include a speed control module 152 and a steering control module 154.

The speed control module 152 may increase or decrease the speed of a vehicle or maintain the speed of a vehicle in a predetermined range according to a control signal from the control unit 160 which will be described later. The speed control module 152 may decrease the speed of the vehicle by driving a braking device included in the vehicle or adjust the speed of the vehicle by adjusting the amount of fuel, air, or power supplied to an engine.

The steering control module 154 may maintain a traveling direction (e.g., a heading angle) of the vehicle within a predetermined range according to a control signal from the control unit 160 which will be described later. The steering control module 154 may control the vehicle to not leave a boundary of a target parking space, even without intervention of a driver, by controlling a motor driven power steering (MDPS) device included in the vehicle.

The control unit 160 may control overall operation of the parking space recognition apparatus 100. Specifically, the control unit 160 may process information input and output through the sensing unit 110, the information storage unit 120, the image synthesis unit 130, the interface 140, and the driving unit 150. The control unit 160 may provide proper information or functions to a user by driving an application program stored in the information storage unit 120.

The control unit 160 may generate an obstacle map of obstacles surrounding the vehicle based on a sensing signal provided by the sensing unit 110 or an AVM image provided by the image synthesis unit 130, and may recognize a parking space from the generated obstacle map.

The control unit 160 may set parking spaces having characteristics of stored valid parking spaces among the recognized parking spaces as candidate parking spaces and determine any one of the candidate parking spaces as a target parking space. The target parking space means a region or a space in which the vehicle is actually to be parked.

The control unit 160 may include an estimation module 162, a comparison module 164, and a correction module 166.

The estimation module 162 may estimate a location of at least one crossing included in a parking space drawn on a road surface around the vehicle from the AVM image. The estimation module 132 may calculate an estimated location value which is a coordinate of the estimated location.

The comparison module 164 may compare the estimated location value calculated by the estimation module 162 with a registered location value stored in the information storage unit 120 to determine whether a crossing corresponding to the estimated location value is identical to a crossing corresponding to the registered location value.

To this end, the comparison module 164 determines whether at least one registered location value stored in the information storage unit 120 is present. If no registered location value is stored in the information storage unit 120, the comparison module 164 may store the estimated location value calculated by the estimation module 162 as a registered location value of a crossing corresponding to the estimated location value.

If one or more registered location values stored in the information storage unit 120 are present, the comparison module 164 may determine whether a registered location value matching the estimated location value calculated by the estimation module 162 is present among the stored registered location values. Whether the estimated location value and the registered location value match is determined based on a distance therebetween and a detailed description thereof will be given later.

If the registered location value matching the estimated location value is not present in the information storage unit 120, the comparison module 164 may store the estimated location value calculated by the estimation module 162 as a registered location value of a crossing corresponding to the estimated location value.

If it is determined that the registration location matching the estimated location value is present, the correction module 166 may correct the registered location value matching the estimated location value using the estimated location value and store the corrected registered location value. That is, the correction module 166 may replace a registered location value prior to correction with a registered location value after correction. In this case, the location value prior to correction may be deleted from the information storage unit 120.

Only one registered location value per crossing may be stored in the information storage unit 120. As such, as compared with a conventional scheme of calculating a plurality of location values per crossing and recognizing the location of a crossing by averaging the multiple location values, memory may be efficiently used and computational load may be reduced.

The parking space detection module 168 may verify validity of a parking space drawn around the vehicle, based on registered location values stored in the information storage unit 120. The parking space detection module 168 may calculate a distance between the stored registered location values and verify that a parking space including crossings corresponding to the registered location values is valid when the calculated distance is greater than the width of the vehicle. In this case, even when a distance between two stored registered location values is greater than the width of the vehicle, if no parking line is recognized between two crossings corresponding to the two registered location values, the parking space detection module 168 may regard the two crossings as being included in a non-valid parking space.

The parking space detection module 168 may generate a parking path for a parking space verified as being valid. The above-described driving unit 150 may cause the vehicle to be parked within the valid parking space by controlling at least one of the speed and steering of the vehicle along the parking path generated by the parking space detection module 168.

Meanwhile, the parking space recognition apparatus 100 described with reference to FIG. 3 may be installed in a vehicle.

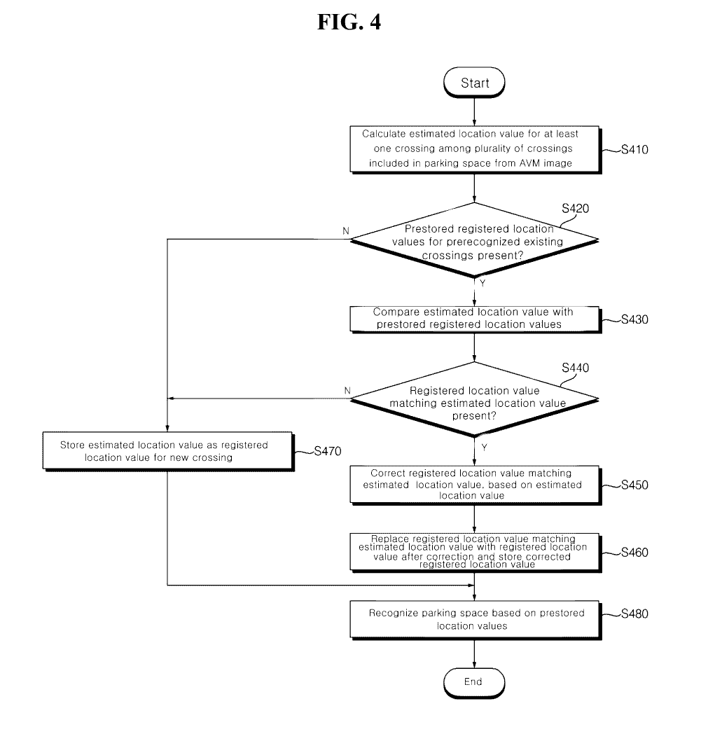

FIG. 4 is a flowchart illustrating a method of controlling the parking space recognition apparatus 100 according to an exemplary embodiment.

Referring to FIG. 4, the control unit 160 calculates an estimated location value for at least one crossing among a plurality of crossings included in a parking space from an AVM image (S410). The estimated location value may be represented in a coordinate format of a plane coordinate system.

Next, the control unit 160 may determine whether registered location values stored in the information storage unit 120 are present (S420). That is, the control unit 160 may determine whether registered location values, which are the locations of one or more existing crossings prerecognized in the past, have been stored in the information storage unit 120. In this case, the registered location values may also be represented in a coordinate format of the plane coordinate system as in the estimated location value.

The existing crossings may be crossings included in the parking space of step S410 or may be crossings included in a parking space different from the parking space of step S410. In this case, the stored registered location values may be stored such that one registration value corresponds to one existing crossing.

If it is determined that the registered location values for one or more existing crossings have been stored in the information storage unit 120 in step S420, the control unit 160 may compare the estimated location value calculated in step S410 with the registered location values stored in the information storage unit 120 (S430). If multiple registered location values are stored in the information storage unit 120, the control unit 160 may compare each of the registered location values with the estimated location value. For example, the control unit 160 may calculate a distance between each of the registered location values and the estimated location value in step S430.

As a result of comparison in step S430, the control unit 160 may determine whether a registered location value matching the estimated location value is present among the one or more stored registered location values (S440). That is, the control unit 160 may determine whether a registered location value for the same existing crossing as a crossing corresponding to the estimated location value has been stored in the information storage unit 120. The control unit 160 may determine that a registered location value when a distance to the estimated location value is less than a reference distance matches the estimated location value.

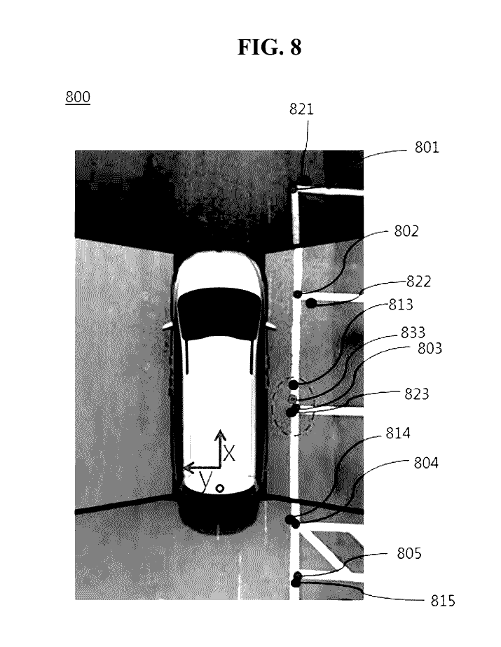

Upon determining that the registered location value matching the estimated location value is present in step S440, the control unit 160 may correct the registered location value matching the estimated location value, based on the estimated location value (S450). An operation of correcting the registered location value matching the estimated location value, based on the estimated location value, will be described in more detail with reference to FIG. 8.

The control unit 160 may replace the registered location value for the existing crossing corresponding to the estimated location value with the registered location value corrected in step S450 and store the corrected registered location value (S460). That is, the control unit 160 may update the registered location value for the existing crossing prior to correction to the registered location value after correction.

If it is determined that no registered location values stored in the information storage unit 120 are present in step S420 or if it is determined that no registered location value matches the estimated location value among the stored registered location values in step S440, the control unit 160 may store the estimated location value as a registered location value for a new crossing (S470). That is, if no registered location value is stored in the information storage unit 120 or if a registered location value stored in the information storage 120 is present but does not match the estimated location value, this may mean that a crossing corresponding to the estimated location value was never recognized in the past. Then, the control unit 160 may process the estimated location value calculated in step S410 as corresponding to a new crossing.

Next, the control unit 160 may recognize a parking space based on the registered location values stored in the information storage unit 120 (S480). To recognize a parking space, registered location values for two or more crossings should be stored.

For example, when first and second registered location values are stored in the information storage unit 120, a distance therebetween is calculated by comparing the two values. If the calculated distance exceeds the width of a vehicle, the control unit 160 may recognize a parking lot including a first crossing corresponding to the first registered location value and a second crossing corresponding to the second registered location value.

The control unit 160 may calculate the size and location of the parking space based on registered location values including a corrected registered location value and generate a parking path for the parking space based on the calculated size and location of the parking space. In addition, the control unit 160 may control the driving unit 150 to cause the vehicle to travel along the parking path.

The above-described steps S410 to S460 may be repeated until the parking space is recognized through step S470.

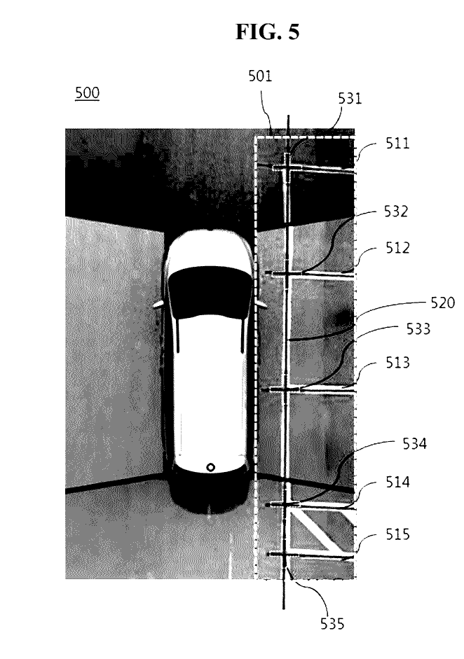

FIG. 5 illustrates an example of detecting a crossing of a parking space from an AVM image 500 by the parking space recognition apparatus 100 according to an exemplary embodiment.

Referring to FIG. 5, the image synthesis unit 130 may generate the AVM image 500 as illustrated, and the control unit 160 may detect first straight line components 511 to 515 and a second straight line component 520 from at least one region 501 of the AVM image 500. The first straight line components 511 to 515 and the second straight line component 520 may be detected based on a light and dark pattern of a parking line appearing in one region 501.

The first straight line components 511 to 515 and the second straight line component 520 may be orthogonal. For example, the first straight line components 511 to 515 may have a horizontal direction and the second straight line component 520 may have a vertical direction.

The control unit 160 may calculate an estimated location value for at least one of points 531 to 535 at which the first straight line components 511 to 515 and the second straight line component 520 cross (hereinafter, crossings). For example, the control unit 160 may calculate an equation of the first straight line components 511 to 515 and an equation of the second straight line component 520 to obtain crossings between the first straight line components 511 to 515 and the second straight line component 520.

At least one of the first to fifth crossings 531 to 535 has been recognized by the control unit 160 and then a registered location value therefor has been stored in the information storage unit 120. For example, among the first to fifth crossings 531 to 535, the fourth and fifth crossings 534 and 535 may have been recognized at a first time point and registered location values therefor may have been stored in the information storage unit 120. At a second time point after a first timing point, estimated location values for the second to fourth crossings 532 to 534 may be calculated.

In this case, the estimated location value for the fourth crossing 534 recognized at the second time point may match the stored registered location value for the fourth crossing 534 which has already been recognized at the first time point. In this case, the fourth crossing 534 corresponds to an existing crossing based on the second time point and the control unit 160 may correct the registered location value for the fourth crossing 534 using the estimated location value for the fourth crossing 534.

The second and third crossings 532 and 533 recognized at the second time point may correspond to new crossings that were not recognized at the first time point and, therefore, registered location values for the second and third crossings 532 and 533 may not have been stored in the information storage unit 120. Therefore, the control unit 160 may store the estimated location values for the second and third crossings 532 and 533 as the registered location values for the second and third crossings 532 and 533 in the information storage unit 120. The registered location values for the second to fourth crossings 532 to 534 recognized at the second time point may be corrected and updated according to a recognition result after the second time point.

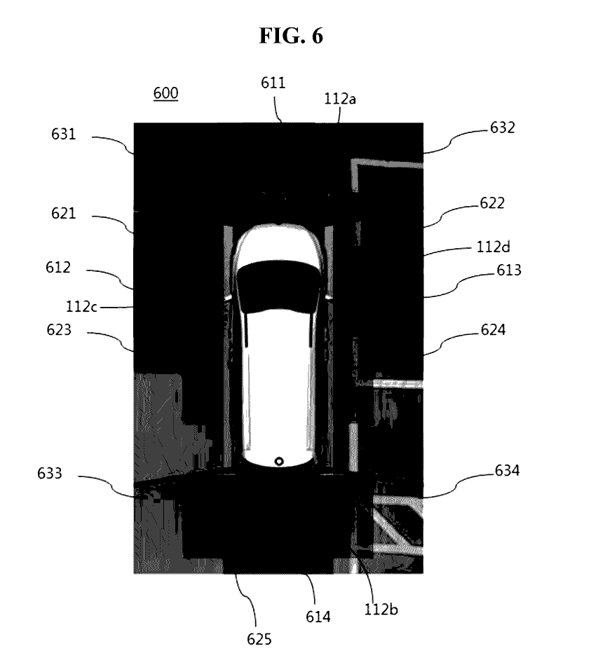

FIG. 6 illustrates an example of a reliability index set with respect to each region of an AVM image 600 according to an exemplary embodiment.

As described above, among all regions of the AVM image 600, distortion may be significant in a region further from the cameras 112a to 112d, and a crossing detected from the region in which distortion is significant may not be an actual crossing.

To solve such a problem, the exemplary embodiments use a scheme of dividing the entire region of the AVM image 600 into a plurality of sub-regions, and defining different reliability indexes with respect to the respective divided sub-regions.

As illustrated in FIG. 6, the entire region of the AVM image 600 may be divided into four first sub-regions 611 to 614, five second sub-regions 621 to 625, and four third sub-regions 631 to 634.

The information storage unit 120 may store a first reliability index for the first sub-regions 611 to 614, a second reliability index for the second sub-regions 621 to 625, and a third reliability index for the third sub-regions 631 to 634. In this case, the first to third reliability indexes may have different values such that the first reliability index has the largest value and the third reliability index has the smallest value.

The reliability indexes may be used to correct registered location values, which will be described with reference to FIG. 8.

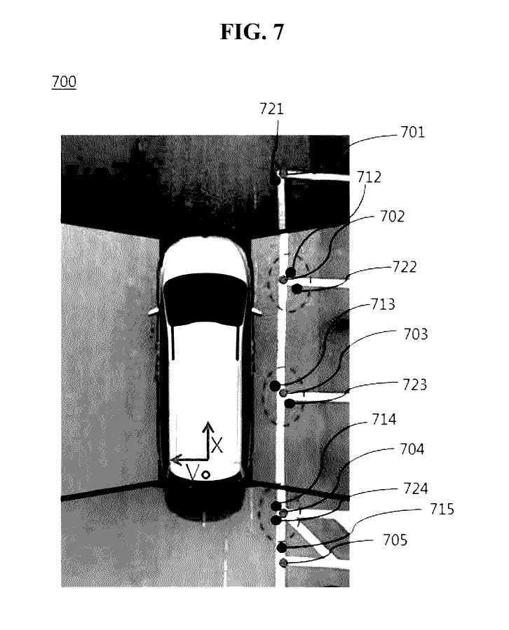

FIG. 7 illustrates an example of detecting the location of a new crossing from an AVM image 700 by the parking space recognition apparatus 100 according to an exemplary embodiment.

For convenience of description, it is assumed that second to fifth crossings 702 to 705 among first to fifth crossings 701 to 705 illustrated in FIG. 7 have already been recognized and second to fifth registered location values 712 to 715 have been stored in the information storage unit 120.

Under this state, the control unit 160 may calculate first to fourth estimated location values 721 to 724 for the first to fourth crossings 701 to 704, respectively, from the AVM image 700.

In this case, an estimated location value for the fifth crossing 705 may not be calculated for various reasons. For example, in a situation in which the fifth crossing 705 is out of the range of the AVM image 700 and the vehicle speeds up, estimated location values for some crossings of a parking space may not be calculated.

The control unit 160 may determine whether registered location values respectively matching the first to fourth estimated location values 721 to 724 have been stored in the information storage unit 120. Separately from processing of the second to fourth registered location values 712 to 714 matching the second to fourth estimated location values 722 to 724, the registered location value for the first crossing 701 may not have been stored in the information storage unit 120 and the control unit 160 may determine that the registered location value matching the first estimated location value 721 is not present in the information storage unit 120.

Accordingly, the control unit 160 may determine that the first crossing 701 corresponding to the first estimated location value 721 is a new crossing and may store the first estimated location value 721 as the registered location value 721 for the new crossing 701.

The control unit 160 may determine that the second to fourth crossings 702 to 704 corresponding to the second to fourth estimated location values 722 to 724 are existing crossings and may update the second to fourth registered location values 712 to 714 based on the second to fourth estimated location values 722 to 724.

An operation of correcting and updating existing crossings will be described in detail with reference to FIG. 8.

FIG. 8 illustrates an example of correcting a location value calculated for an existing crossing from an AVM image 800 by the parking space recognition apparatus 100 according to an exemplary embodiment.

For convenience of description, it is assumed that third to fifth crossings 803 to 805 among first to fifth crossings 801 to 805 illustrated in FIG. 8 have already been recognized and third to fifth registered location values 813 to 815 therefor have been stored in the information storage unit 120.

Under this state, the control unit 160 may calculate first to third estimated location values 821 to 823 for the first to third crossings 801 to 803, respectively, from the AVM image 800.

Separately from a process for determining crossings corresponding to the first and second estimated location values 821 and 922 as new crossings, the control unit 160 may determine whether the third estimated location value 823 for the third crossing 803 matches the third registered location value 813 stored for the third crossing 803.

For example, the control unit 160 may calculate a Mahalanobis distance between the “third estimated location value 823” and the “third registered location value 813” or between the “third estimated location value 823” and an “average of estimated location values that have been calculated for the third crossing 803 before the third estimated location value 823 for the third crossing 803” is calculated and, if the Mahalanobis distance is less than a preset reference distance, the control unit 160 may determine that the third estimated location value 823 matches the third registered location value 813.

The Mahalanobis distance between two different locations may be calculated using Equation 1.

D=\sqrt{(Pₙ₊₁−mₙ)^{T}Cₙ⁻¹(Pₙ₊₁−mₙ)} [Equation 1]

In Equation 1, Pₙ₊₁ is an estimated location value obtained through an (n+1)-th calculation with respect to a specific crossing, mₙ is an average of estimated location values P₁ to Pₙ calculated n times in the past with respect to the specific crossing, Cₙ is a covariance matrix of the estimated location values P₁ to Pₙ calculated n times in the past with respect to the specific crossing, and D is a Mahalanobis distance between Pₙ₊₁ and mₙ. In addition, n is a natural number equal to or greater than 1.

For example, when n is 1 in Equation 1, the third estimated location value 823 is P₂ and the third registered location value 813 is m₁.

The covariance matrix Cₙ of Equation 1 may be obtained using Equation 2.

$${C}_{n} = ( \begin{matrix}cov ( x , x ) & cov ( x , y ) \\ cov ( x , y ) & cov ( y , y )\end{matrix} ) = ( \begin{matrix}\frac{1}{n} \sum {( {x}_{i} - {m}_{x} )}^{2} & \frac{1}{n} \sum ( {x}_{i} - {m}_{x} ) ( {y}_{i} - {m}_{y} ) \\ \frac{1}{n} \sum ( {x}_{i} - {m}_{x} ) ( {y}_{i} - {m}_{y} ) & \frac{1}{n} \sum {( {y}_{i} - {m}_{y} )}^{2}\end{matrix} ) \qquad [ Equation 2 ]$$

In Equation 2, xᵢ is an X-axis coordinate value of an estimated location value Pᵢ obtained through an i-th calculation (where i≦n) in the past, yᵢ is a Y-axis coordinate value of the estimated location value Pᵢ obtained through the i-th calculation in the past, mₓ is an X-axis coordinate value of mₙ of Equation 1, and m_{y} is a Y-axis coordinate value of mₙ of Equation 1.

Whether the third estimated location value 823 matches the third registered location value 813 may be determined by a method other than the Mahalanobis distance. The control unit 160 may calculate the distance between the third estimated location value 823 and the third registered location value 813 using the Pythagorean Theorem and, if the calculated distance is less than a reference distance, the control unit 160 may determine that the third estimated location value 823 matches the third registered location value 813.

When it is determined that the third estimated location value 823 matches the third registered location value 813 using the Mahalanobis distance, the control unit 160 may correct the third registered location value 813 based on the third estimated location value 823. In addition, the control unit 160 may correct the third registered location value 813 using Equation 3 based on a reliability index of a sub-region to which the third estimated location value 823 belongs.

C⁻¹=Cᵣ⁻¹+Cₙ⁻¹

Qₙ₊₁=C⁻¹×[(Cᵣ⁻¹×Pₙ₊₁)+(Cₙ⁻¹×Qₙ)] [Equation 3]

In Equation 3, where Cᵣ is a preset covariance matrix corresponding to a reliability index of an estimated location value obtained through an (n+1)-th calculation, Cₙ is a covariance matrix described in Equation 2, Pₙ₊₁ is an estimated location value obtained through an (n+1)-th calculation with respect to a specific crossing as described in Equation 1, Qₙ is a registered location value for the specific crossing prior to correction, Qₙ₊₁ is a registered location value for the specific crossing after correction.

For example, assuming that n is 1 in Equation 3, the third estimated location value 823 is P₂, the third registered location value 813 is Q₁, and a result of correcting the third registered location value 813 based on the third estimated location value 823 is Q₂.

In addition, Cᵣ may be preset to have a small value as the reliability index of the third estimated location value 823 increases.

When the third estimated location value 823 belongs to the first sub-regions 611 to 614 illustrated in FIG. 6, a covariance matrix corresponding to a first reliability index may is be preset to Cᵣ=[1, 0;0, 1] and, if the third estimated location value 823 belongs to the third sub-regions 631 to 634, a covariance matrix corresponding to a third reliability index may be preset to Cᵣ=[5, 0;0, 5].

Referring to FIG. 8, a corrected location value 833 of the third registered location value 813 based on the third estimated location value 823 is illustrated. Specifically, since the third estimated location value 823, rather than the third registered location value 813 prior to correction, is located closer to the third crossing 803, the third registered location value 833 corrected based on the third estimated location value 823 rather than the third registered location value 813 prior to correction is also located nearer the third crossing 803. In this case, the existing registered location value 813 is deleted from the information storage unit 120 and the newly calculated registered location value 833 may be stored in the information storage unit 120 as a value corresponding to the third crossing 803.

That is, by updating the existing registered location value 813 to the new registered location value 833 using the third estimated location value 823, the registered location value 833 nearer an actual location of the third crossing 803 can be obtained. As such, since the control unit 160 recognizes a parking space based on registered location values stored in the information storage unit 120, accuracy of the parking space can be improved, utility of an information storage space is enhanced, and computational load is remarkably reduced.

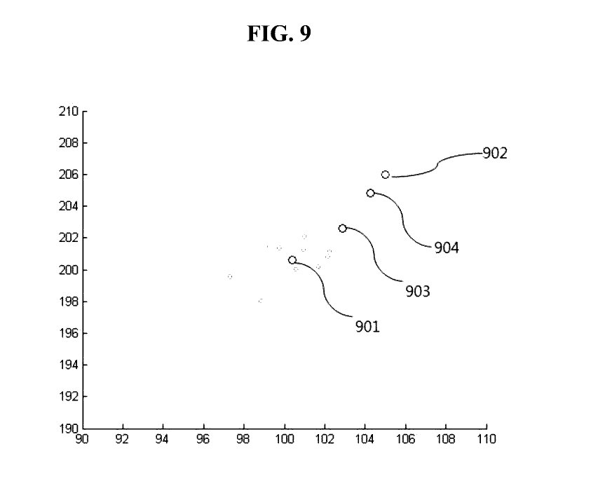

FIG. 9 is a diagram illustrating an example of a correction result by the parking space recognition apparatus 100 according to an exemplary embodiment.

As described previously, the control unit 160 may correct a stored registered is location value with respect to a corresponding crossing based on an estimated location value for any one crossing and a reliability index of a region to which the estimated location value belongs.

In FIG. 9, when it is assumed that a stored registered location value 901 for any one crossing and an estimated location value 902 for the same crossing are fixed, correction for the existing registered location value 901 may depend only on a reliability index.

In FIG. 9, when a reliability value corresponding to the estimated location value 902 is the third reliability index which is the lowest of the first to third reliability indexes shown in FIG. 6, a corrected registered location value 903 based on the third reliability index may be located at a point moved from the registered location value 901 towards the estimated location value 902.

When a reliability value corresponding to the estimated location value 902 is the first reliability index, which is the highest of the first to third reliability indexes shown in FIG. 6, a corrected registered location value 904 based on the first reliability index may be located between the estimated location value 902 and the registered location value 901 and the corrected registered location value 904 rather than the registered location value 903 corrected based on the third reliability index is nearer the estimated location value 902.

This is because the control unit 160 lowers a reflection ratio of a corresponding estimation value in correcting the existing registered location value 901 since accuracy of the estimated location value 902 is lowered as a reliability index set with respect to a region to which the estimated location value 902 belongs in an AVM image decreases.

Conversely, since accuracy of the estimated location value 902 is raised as a reliability index set with respect to the region to which the estimated location value 902 is belongs in the AVM image, the control unit 160 may raise a reflection ratio of a corresponding estimation value in correcting the existing registered location value 901.

The parking space recognition apparatus and the method of controlling the same according to the exemplary embodiments may have the following effects.

According to an exemplary embodiments, memory use and computational load needed to recognize a parking space can be reduced by storing only one location value per cross included in the parking space.

The effects of the exemplary embodiments should not be limited to the aforementioned effects and other not-mentioned effects will be clearly understood by those skilled in the art from the claims.

The exemplary embodiments as described above are not limited to be implemented only via the apparatus and the method and may be implemented via a program that realizes a function corresponding to the configuration of each exemplary embodiment or a recording medium in which the program is recorded. This implementation will be easily realized by experts in the art from the above description of the embodiments.

The parking space recognition apparatus 100 and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like. In this manner, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. As such, the parking space recognition apparatus 100 and/or one or more components thereof may include or otherwise be associated with one or more memories (not shown) including code (e.g., instructions) configured to cause the parking space recognition apparatus 100 and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A method of controlling a parking space recognition apparatus, the method comprising:
calculating an estimated location value for any one of a plurality of crossings comprising a parking space from an around view monitoring (AVM) image;
determining whether stored registered location values for one or more prerecognized existing crossings are present among the plurality of crossings, with one registered location value corresponding to one existing crossing;
if the stored registered location values are present, determining whether a registered location value matching the estimated location value is present among the stored registered location values;
if the registered location value matching the estimated location value is present, correcting the matched registered location value based on the estimated location value; and
replacing a registered location value for an existing crossing corresponding to the estimated location value with the corrected registered location value and storing the corrected registered location value.

2. The method according to claim 1, further comprising,
processing a crossing corresponding to the estimated location value as a new crossing and storing the estimated location value as a registered location value for the new crossing if the stored registered location values are not present or the registered location value matching the estimated location value is not present among the stored registered location values.

3. The method according to claim 1, wherein the determining whether the registered location value matching the estimated location value is present includes:
calculating a distance between the estimated location value and each of the stored registered location values; and
determining that the registered location value matching the estimated location value is present if the calculated distance is less than a preset reference distance or,
determining that the registered location value matching the estimated location value is not present if the calculated distance exceeds the reference distance.

4. The method according to claim 1, further comprising obtaining a reliability index for the estimated location value.

5. The method according to claim 4, wherein obtaining the reliability index includes:
obtaining a sub-region in which the estimated location value belongs among a plurality of predefined sub-regions with respect to an entire region of the AVM image; and
obtaining a preset reliability index with respect to the selected sub-region.

6. The method according to claim 4, wherein correcting the matched registered location value includes obtaining the matched registered location value based on the obtained reliability index.

7. The method according to claim 1, further comprising:
calculating a size and location of the parking space based on registered location values including the corrected registered location value; and
generating a parking path for the parking space based on the size and location of the parking space.

8. A parking space recognition apparatus, comprising:
an information storage unit configured to store data of at least one parking space;
an image synthesis unit configured to generate an around view monitoring (AVM) image; and
a control unit configured to calculate an estimated location value for any one of a plurality of crossings included in a parking space from the AVM image,
determine whether stored registered location values for one or more prerecognized existing crossings are present among the plural crossings,
determine whether a registered location value matching the estimated location value is present among the stored registered location values if the stored registered location values are present,
correct the matched registered location value based on the estimated location value if the registered location value matching the estimated location value is present, and
replace a registered location value for an existing crossing corresponding to the estimated location value with the corrected registered location value and store the corrected registered location value,
wherein one registered location value corresponds to one existing crossing.

9. The parking space recognition apparatus according to claim 8,
wherein the control unit is configured to processes a crossing corresponding to the estimated location value as a new crossing and stores the estimated location value as a registered location value for the new crossing if the stored registered location values are not present or the registered location value matching the estimated location value is not present among the stored registered location values.

10. The parking space recognition apparatus according to claim 8,
wherein the control unit is configured to calculate a distance between the estimated location value and each of the stored registered location values,
determine at the registered location value matching the estimated location value is present if the calculated distance is less than a preset reference distance, and
determines that the registered location value matching the estimated location value is not present if the calculated distance exceeds the reference distance.
